(19) United States
(12) Patent Application Publication
(10) Pub. No.: US 2007/0056697 A1
(43) Pub. Date: Mar. 15, 2007

(54) Electrically driven curtain assembly

(76) Inventor: Yin-Wen Chen, Hsinchu (TW)

Correspondence Address: PRO-TECHTOR INTERNATIONAL SERVICES, 20775 NORADA CT., SARATOGA, CA, 95070, US

(21) Appl. No.: 11/226,527

(22) Filed: Sep. 13, 2005

(51) Int. Cl. E06B 3/94

(52) U.S. Cl. 160/310; 160/168.1 P; 160/84.02

(57) ABSTRACT

A electrically driven curtain assembly comprises a case, a curtain shaft, housed in the case, a curtain, wound up to a varying degree on the curtain shaft, a driving device, driving a rotational movement of the curtain shaft, a control circuit for controlling operation of the driving device, a gear assembly between the driving device and the curtain shaft, and a switching device for regulating opening of the curtain up to a given length, having a blocking piece a gliding plate, which is engaged with an outer thread of the driving device and longitudinally glides thereon when the driving device rotates, so that, when the curtain is lowered, the gliding plate glides towards the blocking piece until a limit position is reached at which a contact switch on the gliding plate is operated, stopping the motor.

### BACKGROUND OF THE INVENTION

1. Field of the Invention

The present invention relates to an electrically driven curtain assembly, particularly to a curtain assembly having a shaft driven by an electric motor which upon turning winds and unwinds a curtain.

2. Description of Related Art

Curtains that allow to be opened and closed have served to adjust transparency of windows as well as to regulate lighting and ventilation through windows according to varying environmental conditions. Conventional curtains are opened and closed manually using cords running over rolls. Operating of several curtains in this way has to be performed one by one, which is inconvenient.

For ease of operation, electrically driven curtain assemblies have been introduced. Conventional electrically driven curtain assemblies, however, only allow to be opened to a fixed size, without any possibility of adjustment thereof. Therefore, before installing a conventional electrically driven curtain assembly, an opening length has to be determined and structural parts with appropriate sizes have to be chosen, with no later adjustment being possible.

### SUMMARY OF THE INVENTION

It is the main object of the present invention to provide an electrically driven curtain assembly having an opening length that is adjustable after installation to adapt to windows of varying sizes.

Another object of the present invention is to provide an electrically driven curtain assembly having a sensor for light conditions on both sides and automatically opening and closing accordingly.

The present invention can be more fully understood by reference to the following description and accompanying drawings.

### DETAILED DESCRIPTION OF THE PREFERRED EMBODIMENTS

As shown in FIG. 1, the electrically driven curtain assembly of the present invention comprises: a case 10, mounted at a top side of a window; a curtain shaft 20, placed inside the case 10 and horizontally oriented; a curtain 30; a driving device 40; a control circuit 46; and a gear assembly 50. The curtain 30 has an inner end that is wound up on the curtain shaft 20 and an outer end to which a leading rod 31 with a certain weight is attached. When the curtain shaft 20 rotates in one direction, the curtain 30 is wound up thereon, with the leading rod 31 rising. When the curtain shaft 20 rotates in an opposite direction, the curtain 30 is unwound, with the leading rod 31 descending. The driving device 40 has a motor 41 and a driving shaft 42, which is provided with an inner gear for reducing a rotational speed of the motor 41 and increasing torque, and serves to drive a rotational movement of the curtain shaft 20. The control circuit 46 controls operation of the driving device 40. The gear assembly 50 is inserted between the motor 41 and the curtain shaft 20, allowing the curtain shaft 20 to be driven by the motor 41.

Referring to FIGS. 1-4, the gear assembly 50 comprises a primary wheel 51, a driving belt 52, and a secondary wheel 53. The primary wheel 51 is set on an extension rod 43 which is connected with the driving shaft 42 by a connecting sleeve 45, thereby being driven by the motor 41. The secondary wheel 53 is set on a far end of the curtain shaft 20. The driving belt 52 runs over the primary and secondary wheels 51, 53, being driven by the primary wheel 51 and in turn driving the rotational movement of the curtain shaft 20. As shown in FIG. 4, the driving belt 52 has teeth on an inner side thereof to avoid slipping against the primary and secondary wheels 51, 53.

Referring to FIG. 1b, the present invention in a second embodiment has a primary gear 51a and a secondary gear 53a directly engaging with each other.

The control circuit 46 controls operation of the driving device 40 and thereby opening and closing of the curtain 30. The control circuit 46 is in turn controlled by a switch or a remote control device. An external light sensor 47 detects lighting conditions on both sides of the window and generates signals which are transmitted to the control device 46 for controlling opening and closing of the curtain 30, so as to provide desirred lighting conditions on one side of the window. Sensitivity of the light sensor 47 is adjusted by a light sensor adjusting device 471.

As shown in FIGS. 2 and 3, the curtain 30 opens and closes by being lowered and raised, respectively. A vertical position of the curtain 30 is controlled by a pressure sensor or another suitable device. In the embodiment shown, the control circuit 46 senses an electric current drawn by the motor 40 to determine whether the curtain 30 upon rising has reached an uppermost position. In the uppermost position of the curtain 30, the leading rod 31 has reached the case 10, blocking the curtain 30 from rising further. At this moment, the electric current through the motor 40 increases, which is sensed by the control circuit 46, which thereupon stops the motor 40, so that the curtain 30 stays at the uppermost position. On the other hand, how far the curtain 30 descends while opening, is controlled by a switching device 60. As shown in FIGS. 4 and 5, the regulator 60 comprises a gliding plate 61, a contact switch 62, and a blocking piece 64. The gliding plate 61 has a central hole with an inner thread which is engages with an outer thread 44 on the extension rod 43, so that the gliding plate 61 moves along the extension rod 43 as the motor 41 is operated. The contact switch 62 is attached to a side of the gliding plate 61, having a contact element 63. When the contact element 63 is touched, the contact switch 62 is operated, stopping the motor 41. When the contact switch 62 on the gliding plate 61 glides to a limit position, the contact element 63 touches the blocking piece 64, the contact switch 62 is operated, and the motor 41 stops.

Referring again to FIGS. 1-5, when the curtain 30 rises and descends, the gliding plate 61 moves in opposite directions. The blocking piece 64 is mounted in a position that is approached by the gliding plate 61 when the curtain 30 descends. Therefore, when the curtain 30 is lowered, the gliding plate 61 and the contact switch 62 gradually approach the blocking piece 64. At the limit position of the gliding plate 61, the contact element 63 of the contact switch 62 touches the blocking piece 64, so that the contact switch 62 is operated and the motor 41 consequently stops. The limit position of the gliding plate 61 corresponds to a lowermost position of the curtain 30.

The lowermost position of the curtain 30 is adjusted by an opening adjusting device 80, which works by shifting the position of the blocking piece 64 and thereby shifting the limit position of the gliding plate 61. The opening adjusting device 80 has a threaded rod 81 borne by several bearings 82 with inner threads and oriented parallel to the extension rod 43. Turning the threaded rod 81 shifts a longitudinal position thereof. A knob 84 is via a connecting element 83 connected with the threaded rod 81 and allows to turn the threaded rod 81 manually, shifting the longitudinal position thereof. In the embodiment shown, the connecting element 83 is a flexible rod (an elastic rod in the Fig.), allowing to turn the threaded rod 81 from various access angles. The blocking piece 64 is also replaceable by the threaded rod 81 itself.

Referring again to FIG. 5, by turning the threaded rod 81, the position of the blocking piece 64 is shifted, and the lowermost position of the curtain 30 is consequently adjusted. In the embodiment shown, when the blocking piece 64 is moved towards the gliding plate 61, the contact switch 62 is brought closer to the blocking piece 64, with the effect that the lowermost position of the curtain 30 is raised. On the other hand, when the blocking piece 64 is moved away from the gliding plate 61, the contact switch 62 is brought further away from the blocking piece 64, with the effect that the lowermost position of the curtain 30 is lowered.

In above explanation, the contact switch 62 has been assumed to be fixed on the gliding plate 61. Of course, instead fixing the blocking piece on the gliding plate 61 will result in the same effect.

To prevent the gliding plate 61 from turning along with the outer thread 44, the gliding plate 61 is placed in a gliding rail 69. As shown in FIGS. 4-6, the gliding rail 69 surrounds the gliding plate laterally and from below and is oriented parallel to the extension rod 43, therefore allowing only for gliding of the gliding plate 61 parallel thereto and blocking any turning of the gliding plate 61. Cross sections of the gliding rail 69 that are shaped like the letters, L or U are possible.

Referring now to FIG. 3a, in another embodiment of the present invention, a foldable curtain 30a is used, having guiding cords 32a which are wound around the curtain shaft 20 and a leading rod 31a. The guiding cords 32a pass through holes (not shown) in strip-like sections of the foldable curtain 30a. Turning of the curtain shaft 20 causes the leading rod 31a to rise or descend, with the curtain 30a folding and unfolding, respectively.

Referring to FIG. 3b, the present invention in a further embodiment has a curtain 30b with a plurality of strips 321b oriented at an adjustable inclining angle. The curtain 30b has guiding cords 32b which are wound on the curtain shaft 20 and has a free lower end with a leading rod 31b. The guiding cords 32b pass through holes (not shown) in the strips 321b. The inclining angle of the strips 321b is adjusted by first and second adjusting cords 33b, 34b attached to the strips 321b at opposite edges thereof and having upper ends which are attached to a base plate 35b and lower ends which are attached to the leading rod 31b. Upon turning of the curtain shaft 20, the curtain 30b is raised or lowered. The curtains 30a, 30b employ conventional art and don't need further explanation.

Referring to FIG. 7, the present invention allows to use two curtains of equal or different sizes. In the embodiment shown, left and right gear assemblies 50a, 50b driving inner and outer curtains 30c, 30d. Of course, variations, as shown in FIGS. 3-3b, of one or both of the curtains are possible.

### BRIEF DESCRIPTION OF THE DRAWINGS

FIG. 1 is a perspective view of the electrically driven curtain assembly of the present invention.

FIG. 1b is a side view of the gear of the present invention in the second embodiment.

FIG. 2 is a front view of the electrically driven curtain assembly of the present invention.

FIGS. 3, 3a, 3b are side views of the electrically driven curtain assembly of the present invention having various curtains.

FIG. 4 is a magnified perspective view of the electrically driven curtain assembly of the present invention.

FIG. 5 is a schematic illustration of the switching device and the opening adjusting device of the present invention.

FIG. 6 is a magnified side view of the switching device of the present invention.

FIG. 7 is a top view of the present invention having two gear assemblies and two curtains.

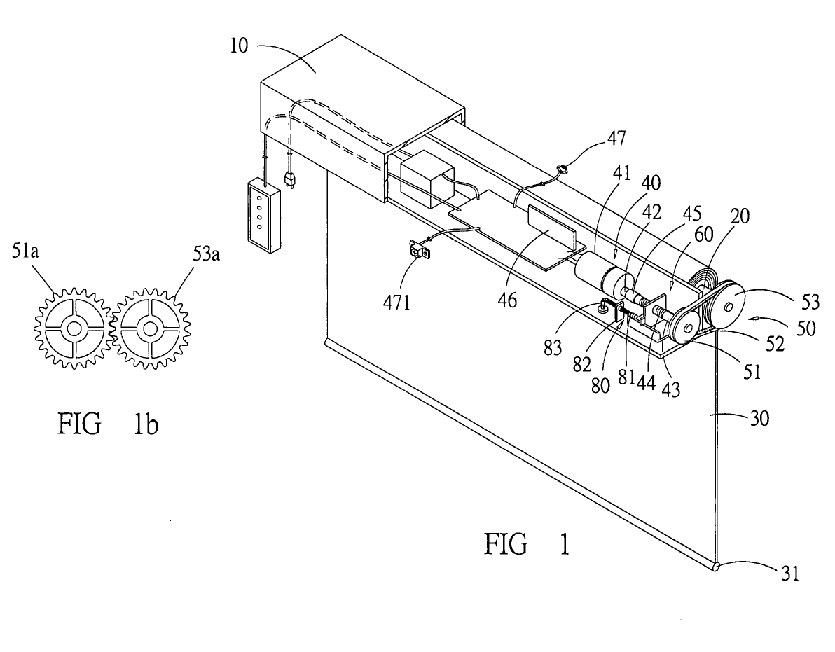

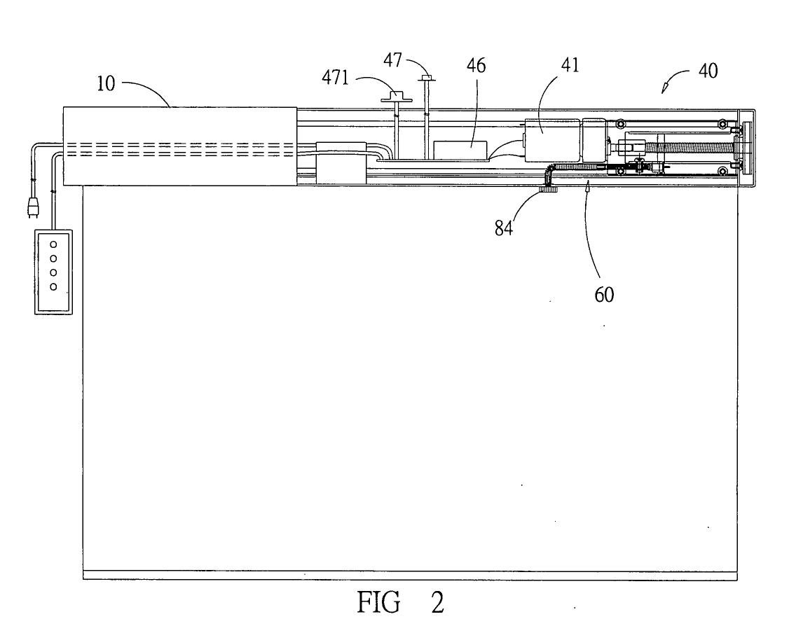

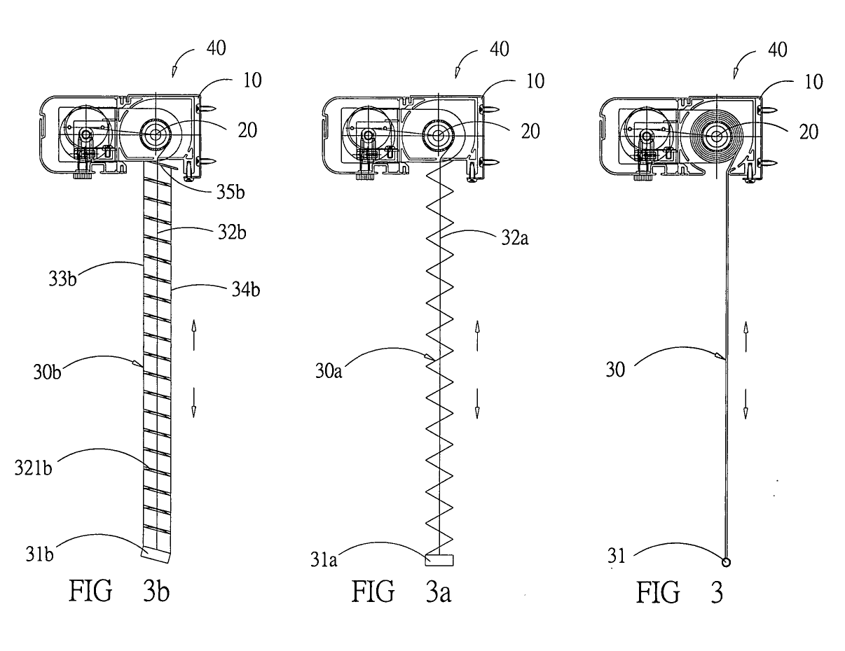

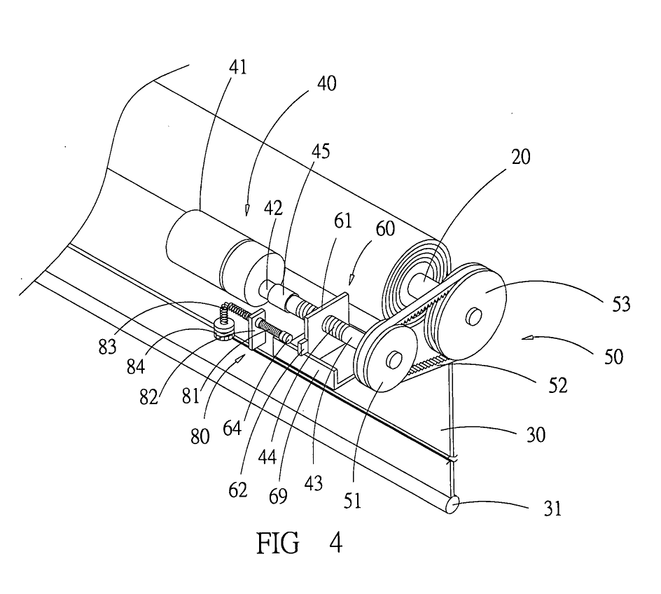

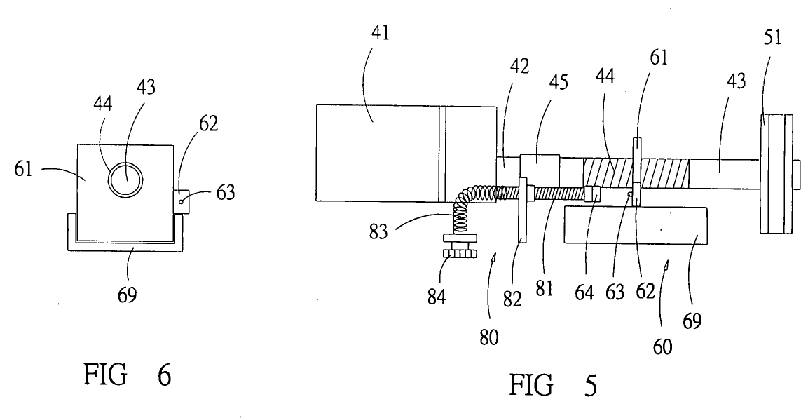

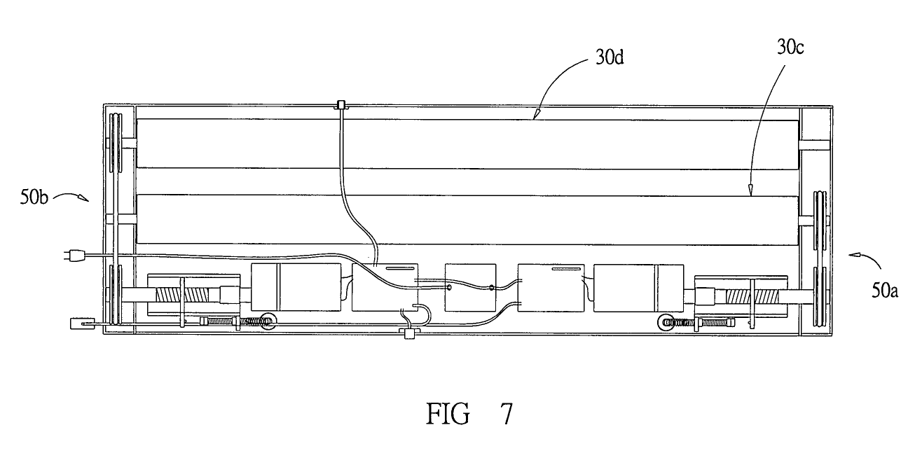

1. An electrically driven curtain assembly, comprising:
a case;
a curtain shaft, housed in said case;
a curtain, wound up to a varying degree on said curtain shaft;
a driving device, driving a rotational movement of said curtain shaft and having a motor and a driving shaft, which is extended by an extension rod;
a control circuit for controlling operation of said driving device;
a gear assembly, inserted between said driving device and said curtain shaft; and
a switching device for regulating opening of said curtain up to a given length, further comprising
a gliding plate which surrounds said extension rod, having a central hole with an inner thread that engages with an outer thread on said extension rod,
a blocking piece at a position to be touched by said gliding plate in a limit position thereof, and
a contact switch, mounted on said gliding plate and at said limit position thereof touching said blocking piece, thereby being operated, whereupon said motor is stopped.

2. The electrically driven curtain assembly according to claim 1, wherein said switching device further has an opening adjusting device for shifting said position of said blocking piece, thereby redefining said limit position of said gliding plate.

3. The electrically driven curtain assembly according to claim 2, wherein said opening adjusting device comprises:
a threaded rod, having a far end to which said blocking piece is attached, thereby upon being turned shifting said position of said blocking piece;
a bearing, having a hole with an inner thread that engages with said threaded rod;
a knob for manually turning said threaded rod; and
a connecting element, connecting said knob with said threaded rod.

4. The electrically driven curtain assembly according to claim 3, wherein said connecting element is a flexible rod with two ends connected to said knob and said threaded rod, respectively.

5. The electrically driven curtain assembly according to claim 1, wherein said gear assembly comprises:
a primary wheel, connected with a far end of said extension rod of said driving device;
a secondary wheel, directly driven by said primary wheel and connected with a far end of said curtain shaft.

6. The electrically driven curtain assembly according to claim 1, wherein said gear assembly comprises:
a primary wheel, connected with a far end of said extension rod of said driving device;
a secondary wheel, connected with a far end of said curtain shaft; and
a driving belt, running over said primary and secondary wheels.

7. The electrically driven curtain assembly according to claim 6, wherein said driving belt has an inner side with teeth.

8. An electrically driven curtain assembly, comprising:
a case;
a curtain shaft, housed in said case;
a curtain, wound up to a varying degree on said curtain shaft;
a driving device, driving a rotational movement of said curtain shaft;
a control circuit for controlling operation of said driving device;
a gear assembly, inserted between said driving device and said curtain shaft; and
a switching device for regulating opening of said curtain up to a given length depending on signals from a light sensor.

9. The electrically driven curtain assembly according to claim 8, wherein said light sensor has a light sensor adjusting device.
